(19) United States
(12) Patent Application Publication
(10) Pub. No.: US 2012/0024552 A1
(43) Pub. Date: Feb. 2, 2012

(54) Inverter Device and Electrical Power Tool

(75) Inventors: Yoshikazu Kawano, Hitachinaka-shi (JP); Nobuhiro Takano, Hitachinaka-shi (JP); Kazuhiko Funabashi, Hitachinaka-shi (JP); Kenro Ishimaru, Hitachinaka-shi (JP); Yasuo Etou, Hitachinaka-shi (JP); Miyoji Onose, Hitachinaka-shi (JP)

(73) Assignee: Hitachi Koki Co., Ltd., Minato-ku (JP)

(21) Appl. No.: 13/184,403

(22) Filed: Jul. 15, 2011

(30) Foreign Application Priority Data
Jul. 30, 2010 (JP) 2010-171707
Jul. 30, 2010 (JP) 2010-172318

(51) Int. Cl. B25F 5/00; H02P 6/14

(52) U.S. Cl. 173/2; 318/400.26

(57) ABSTRACT

An electrical power tool includes a motor, a load detecting unit, a trigger switch, and a power supplying unit. The load detecting unit detects a load applied to the motor. The trigger switch receives an instruction. The power supplying unit starts supplying of a driving electrical power to the motor when the trigger switch receives the instruction. The power supplying unit changes an amount of the driving electrical power based on the load detected by the load detecting unit.

### CROSS REFERENCE TO RELATED APPLICATION

This application claims priorities from Japanese Patent Application No. 2010-171707 and Japanese Patent Application No. 2010-172318 each filed Jul. 30, 2010. The entire content of each of these priority applications is incorporated herein by reference.

### TECHNICAL FIELD

The present invention relates to an inverter device and an electrical power tool.

### BACKGROUND

Japanese Patent Application Publication No. 2009-219428 discloses an electrical power tool, such as, a mower provided with a motor driven with an electrical power.

### SUMMARY

However, since a constant voltage is supplied to the motor in the above mower, an electrical power is wasted when the mower runs idle without mowing a lawn.

In view of the foregoing, it is an object of the invention to provide an electrical power tool capable of reducing a waste of an electrical power.

In order to attain the above and other objects, the invention provides an electrical power tool including: a motor; a load detecting unit that detects a load applied to the motor; a trigger switch that receives an instruction; and a power supplying unit that starts supplying of a driving electrical power to the motor when the trigger switch receives the instruction. The power supplying unit changes an amount of the driving electrical power based on the load detected by the load detecting unit.

Preferably, the power supplying unit determines a driving status of the motor based on the load detected by the load detecting unit, and changes the amount of the driving electrical power based on the determination.

Preferably, the power supplying unit reduces the amount of the driving electrical power when determining that the motor runs idle.

Preferably, the motor is driven with an AC electrical power. The power supplying unit includes: a controller that generates an inverter PWM signal based on the load detected by the load detecting unit; and an inverter circuit having an inverter switch element that is connected to the motor and performs an ON/OFF operation based on the inverter PWM signal to convert a DC electrical power supplied from a DC electrical power to an AC electrical power and supply the AC electrical power to the motor as the driving electrical power, the amount of the driving electrical power changing in accordance with the ON/OFF operation of the inverter switch element.

Preferably, the electrical power tool further includes a transformer switch element electrically connected to the inverter circuit. The controller generates a transformer PWM signal. The DC electrical power is supplied from a battery pack to the transformer switch element, the transformer switch element performing an ON/OFF operation based on the transformer PWM signal, the DC electrical power being converted to the AC electrical power with the ON/OFF operation of the transformer switch element and outputted to the power supplying unit. The power supplying unit further includes: a transformer that transforms the AC electrical power outputted from the transformer switch element; and a rectifying/smoothing unit that rectifies and smoothes the transformed AC electrical power. The inverter circuit converts the rectified and smoothed AC electrical power to the AC electrical power. The controller changes at least one of the inverter PWM signal and the transformer PWM signal based on the load detected by the load detecting unit.

Preferably, the controller generates an inverter PWM signal having a maximum duty and a transformer PWM signal having a maximum duty when the load detected by the load detecting unit is greater than a first threshold. The controller generates an PWM signal having a duty smaller than the maximum duty when the load detected by the load detecting unit is smaller than a second threshold smaller than the first threshold, the PWM signal including at least one of the inverter PWM signal and the transformer PWM signal.

Preferably, the power supplying unit stops supplying of the driving electrical power supplied to the motor when an overdischarge signal is inputted from the battery pack.

Preferably, the load detecting unit detects the load based on a current flowing into the motor.

Another aspect of the present invention provides an electrical power tool including: a motor; a load detecting unit that detects a load applied to the motor; a trigger switch that receives a first instruction; a power supplying unit that starts supplying of a driving electrical power to the motor when the trigger switch receives the first instruction; and a setting unit that receives a second instruction. The power supplying unit changes an amount of the driving electrical power when the setting unit receives the second instruction.

Another aspect of the present invention provides an electrical power tool including: an AC motor driven with an AC electrical power; a trigger switch that receives an instruction; an inverter circuit that converts a DC electrical power supplied from a battery pack to an AC electrical power, and supplies the AC electrical power to the AC motor; a controller configured to control the inverter circuit; and a power switch, a driving electrical power being supplied to the controller when the power switch is turned ON. The controller controls the inverter circuit to start converting the DC electrical power to the AC electrical power after the trigger switch receives the instruction.

Preferably, the electrical power tool further includes: a transformer switch element connected between the battery pack and the inverter circuit, the DC electrical power being supplied from the battery pack to the transformer switch element and converted to an AC electrical power by an ON/OFF operation of the transformer switch element; a transformer that transforms the AC electrical power outputted from the transformer switch element; a rectifying/smoothing unit that rectifies and smoothes the transformed AC electrical power, the inverter circuit converting the rectified and smoothed AC electrical power to the AC electrical power; and a transmitting unit that transmits the DC electrical power supplied from the battery pack to the controller via the AC motor when the trigger switch receives the instruction. The controller controls the inverter circuit to start converting the DC electrical power to the AC electrical power after the DC electrical power is transmitted via the AC motor.

Preferably, the power switch is disposed between the battery pack and the controller, and the transmitting unit is disposed between a connecting point between the power switch and the controller and the AC electrical motor.

Preferably, the electrical power tool further includes a trigger detecting unit having a plurality of resistors connected to the AC motor in series, the DC electrical power supplied from the battery pack being divided by the plurality of resistors and outputted to the controller. The controller controls the inverter circuit to start converting the DC electrical power to the AC electrical power after the divided DC electrical power is inputted.

Preferably, the electrical power tool further includes: a transformer switch element connected between the battery pack and the inverter circuit, the DC electrical power being supplied from the battery pack to the transformer switch element and converted to an AC electrical power by an ON/OFF operation of the transformer switch element; a transformer that transforms the AC electrical power outputted from the transformer switch element; and a rectifying/smoothing unit that rectifies and smoothes the transformed AC electrical power, the inverter circuit converting the rectified and smoothed AC electrical power to the AC electrical power. The inverter circuit includes a plurality of inverter switch elements connected between the rectifying/smoothing unit and the AC motor, the rectified and smoothed AC electrical power being converted to an AC electrical power by ON/OFF operations of the plurality of inverter switch elements. The controller controls the inverter circuit to start converting the DC electrical power to the AC electrical power after the DC electrical power is inputted via the AC motor. The controller controls one inverter switch element to turn ON and the other inverter switch element to turn OFF until the DC electrical power is inputted via the AC motor.

Preferably, the electrical power tool further includes a trigger detecting unit having a plurality of resistors connected to the AC motor in series, the DC electrical power supplied from the battery pack being divided by the plurality of resistors and outputted to the controller. The controller controls the inverter circuit to start converting the DC electrical power to the AC electrical power after the divided DC electrical power is inputted. The plurality of inverter switch includes a first switch, a second switch connected to the first switch, a third switch, and a fourth switch connected to the third switch, the first switch and the third switch being connected to a positive terminal of the battery pack, the second switch and the fourth switch being connected to a negative terminal of the battery pack, the AC motor being connected between a connecting point between the first switch and the second switch and a connecting point between the third switch and the fourth switch, the trigger detecting unit being connected to the fourth switch in parallel. The controller controls the first switch to turn ON and the second switch, the third switch, and the fourth switch to turn OFF until the DC electrical power is inputted via the AC motor.

Preferably, the electrical power tool further includes: a transformer switch element connected between the battery pack and the inverter circuit, the DC electrical power being supplied from the battery pack to the transformer switch element and converted to an AC electrical power by an ON/OFF operation of the transformer switch element; a transformer that transforms the AC electrical power outputted from the transformer switch element; and a rectifying/smoothing unit that rectifies and smoothes the transformed AC electrical power, the inverter circuit converting the rectified and smoothed AC electrical power to the AC electrical power. The controller controls the transformer switch element to start the ON/OFF operation after the trigger switch receives the instruction.

Preferably, the controller controls the inverter circuit to stop converting the DC electrical power to the AC electrical power when an overdischarge signal is inputted from the battery pack.

Another aspect of the present invention provides an inverter device including; a main body; a load detecting unit that detects a load applied to a motor which is connected to the main body; and a power supplying unit that starts supplying of a driving electrical power to the motor. The power supplying unit changes an amount of the driving electrical power based on the load detected by the load detecting unit.

Another aspect of the present invention provides an inverter device including: a main body; an inverter circuit that converts a DC electrical power supplied from a battery pack to an AC electrical power, and supplies the AC electrical power to a AC motor which is connected to the main body; a controller configured to control the inverter circuit; and a power switch, a driving electrical power being supplied to the controller when the power switch is turned ON. The controller controls the inverter circuit to start converting the DC electrical power to the AC electrical power after a trigger switch connected to the AC motor in series is operated.

### BRIEF DESCRIPTION OF THE DRAWINGS

The particular features and advantages of the invention as well as other objects will become apparent from the following description taken in connection with the accompanying drawings, in which:

FIG. 1 is a side view of a mower according to a first embodiment of the present invention;

FIG. 2 is a circuit diagram of the mower according to the first embodiment;

FIG. 3 is a flowchart of a voltage control performed by a microcomputer according to the first embodiment;

FIG. 4 is an explanation diagram of the voltage control performed by the microcomputer according to the first embodiment;

FIG. 5 is a flowchart of a voltage control performed by the microcomputer according a variation of the first embodiment;

FIG. 6 is a circuit diagram of a mower according to a second embodiment of the present invention;

FIG. 7 is a flowchart of a voltage control performed by a microcomputer according to the second embodiment;

FIG. 8 is an explanation diagram of a voltage control performed by the microcomputer according to a first variation according to the second embodiment;

FIG. 9 is a flowchart of a control of a voltage control performed by the microcomputer according to a second variation according to the second embodiment;

FIG. 10 is a circuit diagram of a mower according to a third embodiment of the present invention;

FIG. 11 is a flowchart of a control of a voltage control performed by a microcomputer according to the third embodiment; and

FIG. 12 is a circuit diagram of a mower according to a fourth embodiment of the present invention.

### DETAILED DESCRIPTION

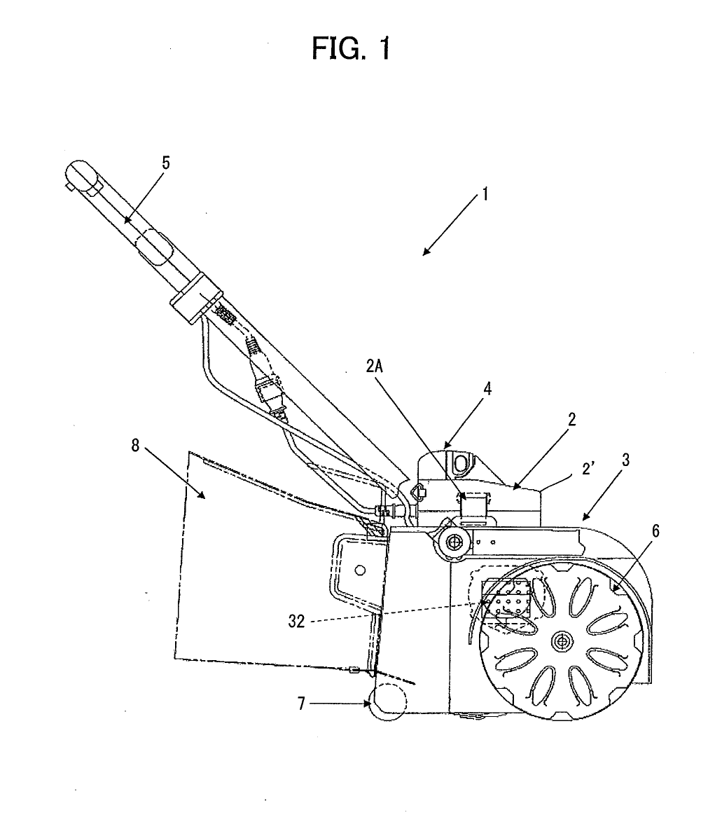

A mower 1 (one example of an electrical power tool) according to a first embodiment of the present invention will be described with reference to FIGS. 1-4.

FIG. 1 is a side view of the mower 1. The mower 1 is provided with a main body 3, an inverter 2 detachable from the main body 3 via a latch 2A, and a battery pack 4. When a trigger switch 31 is operated by a user, an electrical power is supplied from the battery pack 4 to an AC motor 32 via the inverter 2. In the following explanation, it is assumed that the inverter 2 is connected to both the main body 3 and the battery pack 4, though the inverter 2 is detachable from the main body 3 and the battery pack 4. Further, a handle 5, front wheels 6, and rear wheels 7 for allowing the mower 1 to move are provided on the main body 3. A lawn bag 8 for accommodating a lawn mowed by a rotating blade (not shown) connected to the AC motor 32 is detachably provided at a rear side of the main body 3.

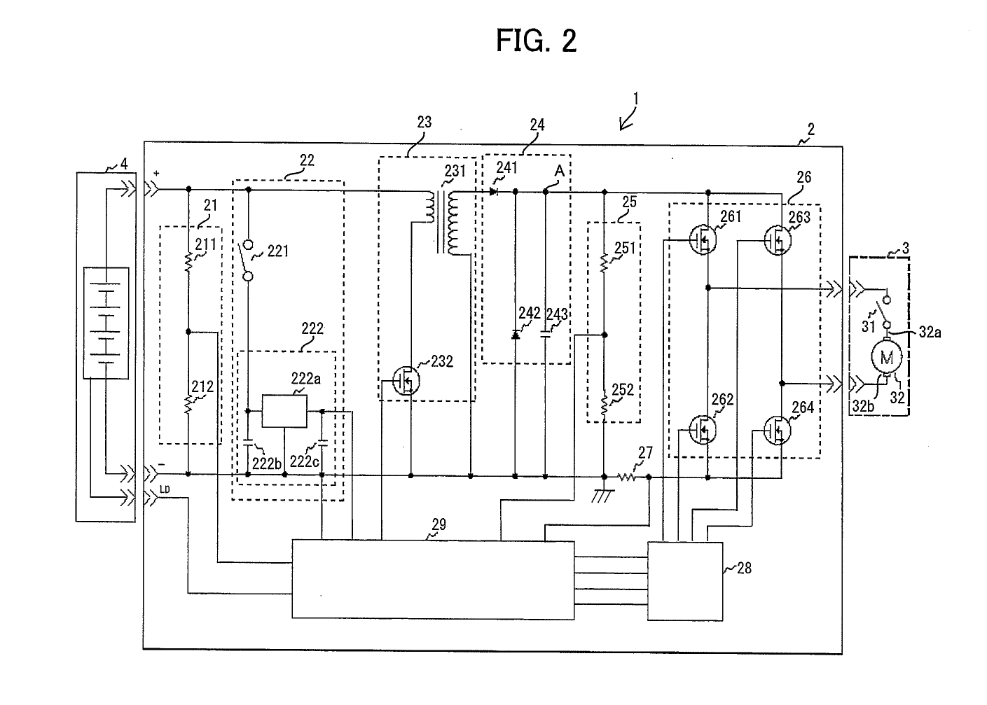

FIG. 2 is a circuit diagram of the mower 1. As described above, the mower 1 includes the inverter 2 and the main body 3. When the trigger switch 31 is operated, the inverter 2 converts a DC electrical power supplied from the battery pack 4 into an AC electrical power, and outputs the AC electrical power to the AC motor 32 of the main body 3.

The inverter (inverter device) 2 includes a main body 2′ that is an outer frame. The main body 2′ accommodates a battery voltage detecting unit 21, a power source 22, a transforming unit 23, a rectifying/smoothing circuit 24, a transformed voltage detecting unit 25, an inverter circuit 26, a current detecting resistor 27, a PWM signal outputting unit 28, and a microcomputer 29.

The battery voltage detecting unit 21 includes resistors 211 and 212 connected in series. The voltage supplied from the battery pack 4 is divided by the resistors 211 and 212, and outputted to the microcomputer 29. In the present embodiment, the battery pack 4 includes four lithium battery cells. Since each lithium battery cell has 3.6V of rated voltage, the battery pack 4 has 14.4V of rated voltage.

The power source 22 includes a power switch 221 and a voltage regulator circuit 222 connected in series between the battery pack 4 and the microcomputer 29. The voltage regulator circuit 222 includes a three-terminal regulator 222a and capacitors 222b and 222c for preventing an oscillation. When the power switch 221 is turned ON by a user, the voltage regulator circuit 222 transforms 14.4V of voltage supplied from the battery pack 4 to a predetermined voltage (for example, 5V), and outputs the predetermined voltage to the microcomputer 29 as a driving power. Note that when the power switch 221 is turned OFF, the inverter 2 is halted since the driving power is not supplied to the microcomputer 29.

The transforming unit 23 includes a transformer 231 and an FET 232. A primary side of the transformer 231 and the FET 232 are connected in series between the battery pack 4 and a GND. A gate of the FET 232 is connected to the microcomputer 29. The FET 232 is turned ON/OFF in accordance with a first PWM signal (described later) outputted from the microcomputer 29 to the gate of the FET 232. When the FET 232 is turned ON/OFF, the DC electrical power supplied from the battery pack 4 is outputted to the primary side of the transformer 231 as an AC electrical power. The AC electrical power is transformed by the transformer 231 and outputted from a secondary side of the transformer 231.

The rectifying/smoothing circuit 24, the transformed voltage detecting unit 25, the inverter circuit 26, and the current detecting resistor 27 are connected to the secondary side of the transformer 231.

The rectifying/smoothing circuit 24 includes diodes 241 and 242 and a capacitor 243. The AC voltage transformed by the transformer 231 is rectified by the diodes 241 and 242, and the rectified voltage is smoothed to a DC voltage (for example, 141V) by the capacitor 243.

The transformed voltage detecting unit 25 includes resistors 252 and 252 connected in series. The DC voltage outputted from the rectifying/smoothing circuit 24 is divided by the resistors 211 and 222, and outputted to the microcomputer 29.

The inverter circuit 26 includes four FETs 261-264. The FETs 261 and 262 connected in series and the FETs 263 and 264 connected in series are connected to an output terminal A of the rectifying/smoothing circuit 24 in parallel. Specifically, a drain of the FET 261 is connected to the output terminal A, and a source of the FET 261 is connected to a drain of the FET 262. In a similar manner, a drain of the FET 263 is connected to the output terminal A, and a source of the FET 263 is connected to a drain of the FET 264.

The source of the FET 261 and the drain of the FET 262 are connected to a first terminal 32a of the AC motor 32 of the main body 3 via the trigger switch 31. The source of the FET 263 and the drain of the FET 264 are connected to a second terminal 32b of the AC motor 32. Gates of the FETs 261-264 are connected to the PWM signal outputting unit 28. The FETs 261-264 are turned ON/OFF in accordance with second PWM signals (described later) outputted from the PWM signal outputting unit 28. When the FETs 261-264 are turned ON/OFF, the DC electrical power outputted from the rectifying/smoothing circuit 24 is outputted to the AC motor 32 of the main body 3 as an AC power.

The current detecting resistor 27 is connected between sources of the FETs 262 and 264 and the GND. A high-voltage side terminal of the current detecting resistor 27 is also connected to the microcomputer 29. With this construction, the current flowing into the current detecting resistor 27, that is, the current flowing into the AC motor 32 is outputted to the microcomputer 29 as a voltage.

The microcomputer 29 controls the ON/OFF operation of the FET 232 based on the transformed voltage detected by the transformed voltage detecting unit 25, so that an AC voltage having a target effective voltage is outputted from the transformer 231. Specifically, the microcomputer 29 generates a first PWM signal based on the transformed voltage detected by the transformed voltage detecting unit 25, and outputs the first PWM signal to the gate of the FET 232 to turn ON/OFF the FET 232.

Further, the microcomputer 29 controls the ON/OFF operations of the FETs 261-264 based on the current flowing into the AC motor 32 detected by the current detecting resistor 27, that is, based on the load applied to the AC motor 32, so that an AC voltage suitable to the load is outputted from the inverter circuit 26. Specifically, the microcomputer 29 generates second PWM signals based on the current (load) detected by the current detecting resistor 27, and outputs the second PWM signals via the PWM signal outputting unit 28 to the gates of the FETs 261-264 to turn ON/OFF the FETs 261-264.

In the present embodiment, when the current (load) detected by the current detecting resistor 27 is equal to or greater than a predetermined value, the microcomputer 29 determines that the main body 3 mows a lawn, and alternately turns ON a set of the FETs 261 and 264 (hereinafter called “first set”) and a set of the FETs 262 and 263 (hereinafter called “second set”) at 100% of duty by second PWM signals. Thus, since a greater voltage is supplied to the AC motor 32 when the main body 3 mows a lawn, it becomes possible to effectively mow a lawn.

On the other hands, when the current (load) detected by the current detecting resistor 27 is smaller than a predetermined value, the microcomputer 29 determines that the main body 3 runs idle, and alternatively turns ON the first set and the second set at a duty (for example, 40%) lower than 100% by second PWM signals. Thus, since a smaller voltage is supplied to the AC motor 32 when the main body 3 runs idle, it becomes possible to reduce a waste of an electrical power.

Further, the microcomputer 29 determines an occurrence of an overdischarge in the battery pack 4 based on the battery voltage detected by the battery voltage detecting unit 21. Specifically, when the battery voltage detected by the voltage detecting unit 21 is equal to or smaller than a first overdischarge threshold, the microcomputer 29 determines that an overdischarge is occurring in the battery pack 4, and stops the ON/OFF operation of the FET 232 by a first PWM signal and the ON/OFF operations of the FET 261-264 by second PWM signals.

Further, the battery pack 4 includes a protecting IC or a microcomputer (not shown) that have an overdischarge detecting function. The protecting IC or the microcomputer outputs an overdischarge signal to the microcomputer 29 via a LD terminal, when the battery voltage is equal to or smaller than a second overdischarge threshold larger than the first overdischarge threshold. When also receiving the overdischarge signal, the microcomputer 29 stops the ON/OFF operation of the FET 232 by a first PWM signal and the ON/OFF operations of the FET 261-264 by second PWM signals. With this construction, the life of the battery pack 4 is prevented from being shorten. The protection IC or the microcomputer outputs an overdischarge signal to the microcomputer 29 via the LD terminal, when the at least one cell voltage of the battery pack 4 is equal to or smaller than a third overdischarge threshold of the cell.

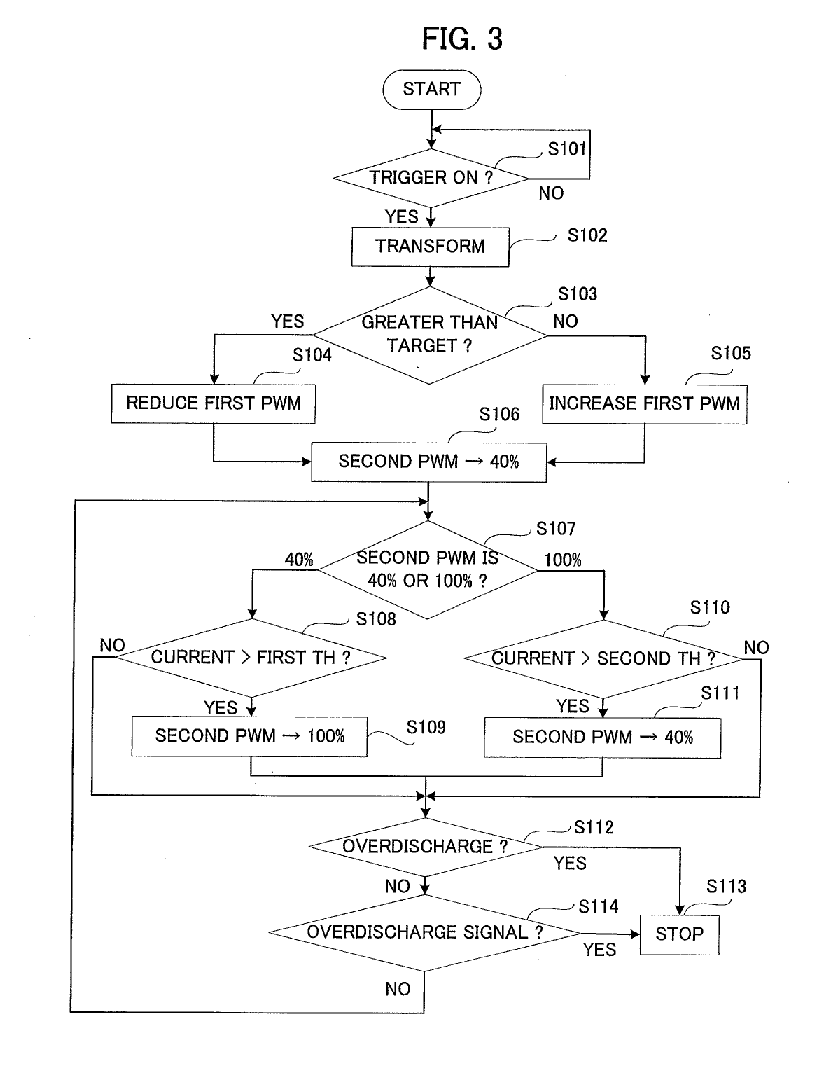

Next, a voltage control performed by the microcomputer 29 will be described with reference to FIG. 3.

A flowchart shown in FIG. 3 starts when the power switch 221 is turned ON in a state where the battery pack 4 has been connected to the inverter 2, or when the battery pack 4 is connected to the inverter 2 in a state where the power switch 221 has been turned ON.

First, the microcomputer 29 determines whether or not the trigger switch 31 has been turned ON (S101). When the trigger switch 31 has been turned ON (S101: YES), the microcomputer 29 starts the ON/OFF operation of the FET 232, that is, the transforming operation of the transformer 231 by a first PWM signal (S102).

Next, the microcomputer 29 determines, based on the transformed voltage detected by the transformed voltage detecting unit 25, whether or not the transformed voltage is greater than a target voltage (for example, 141V) (S103). When the transformed voltage is greater than the target voltage (S103: YES), the microcomputer 29 reduces the duty of the first PWM signal (S104). On the other hands, when the transformed voltage is smaller than the target voltage (S103: NO), the microcomputer 29 increases the duty of the first PWM signal (S105).

Next, the microcomputer 29 sets the duty of second PWM signals to 40% to supply an AC voltage having 40V of effective voltage to the AC motor 32 (S106). As described later, in the present embodiment, the duty of second PWM signals is set to one of 40% and 100%.

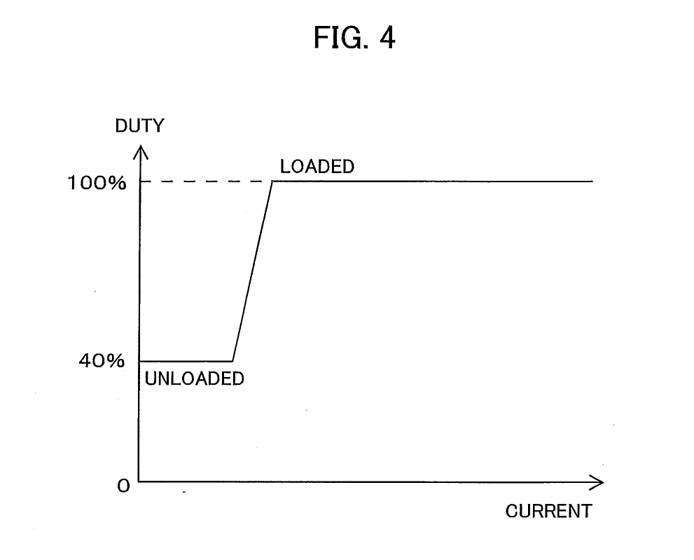

Next, the microcomputer 29 determines which of 40% and 100% the duty of the second PWM signals is set to (S107). When the duty is set to 40% (S107: 40%), the microcomputer 29 determines whether or not the current (load) detected by the current detecting resistor 27 is greater than a first threshold (S108). When the current (load) is greater than the first threshold (S108: YES), the microcomputer 29 determines that the main body 3 mows a lawn, and changes the duty of the second PWM signals to 100% to supply an AC voltage having 100V to the AC motor 32 as shown in FIG. 4 (S109), and goes to S112. On the other hands, when the current (load) is equal to or smaller than the first threshold (S108: NO), the microcomputer 29 determines that the main body 3 runs idle, or the load applied to the AC motor 32 is small although the main body 3 mows a lawn, and goes to S112 without going to S109.

On the other hands, when the duty is set to 100% (S107: 100%), the microcomputer 29 determines whether or not the current (lead) detected by the current detecting resistor 27 is smaller than a second threshold smaller than the first threshold (S110). When the current (load) is smaller than the second threshold (S110: YES), the microcomputer 29 determines that the main body 3 runs idle, and changes the duty of the second PWM signals to 40% to supply an AC voltage having 40V to the AC motor 32 (S111), and goes to S112. On the other hands, when the current (load) is equal to or greater than the second threshold (S110: NO), the microcomputer 29 determines that the main body 3 mows a lawn, and goes to S112 without going to S111.

Next, the microcomputer 29 determines whether or not the battery voltage detected by the battery voltage detecting unit 21 is smaller than the first overdischarge voltage (S112). When the battery voltage detected by the battery voltage detecting unit 21 is smaller than the overdischarge voltage (S112: YES), the microcomputer 29 determines that an overdischarge is occurring in the battery pack 4, and stops the ON/OFF operation of the FET 232 by a first PWM signal and the ON/OFF operations of the FETs 261-264 by second PWM signals to stop the operations of the transforming unit 23 and the inverter circuit 26 (S113). As the result, the power supply to the AC motor 32 is stopped.

When the battery voltage detected by the battery voltage detecting unit 21 is equal to or greater than the overdischarge voltage (S112: NO), the microcomputer 29 determines whether or not the overdischarge signal has been inputted from the battery pack 4 (S114). When the overdischarge signal has been inputted from the battery pack 4 (S114: YES), the microcomputer 29 stops the ON/OFF operation of the FET 232 by a first PWM signal and the ON/OFF operations of the FETs 261-264 by second PWM signals to stop the operations of the transforming unit 23 and the inverter circuit 26 (S113). On the other hands, when the overdischarge signal has not been inputted from the battery pack 4 (S114: NO), the microcomputer 29 returns to S107 to continue a voltage control based on the current (load).

Thus, in the present embodiment, since the occurrence of the overdischarge in the battery pack 4 is detected by both the battery pack 4 and the inverter 2, it becomes possible to reliably prevent the occurrence of the overdischarge.

As described above, the mower 1 according to the present embodiment changes the driving power supplied to the AC motor 32 based on the load applied to the AC motor 32. Specifically, the mower 1 increases the driving power when the load applied to the AC motor 32 is equal to or greater than a predetermined value, and decreases the driving power when the load applied to the AC motor 32 is smaller than a predetermined value. With this construction, it becomes possible to reduce the waste of the electrical power when the mower 1 runs idle.

Note that the driving power supplied to the AC motor 32 may be changed by changing the duty of first PWM signals without changing the duty of second PWM signal. Further, the driving power supplied to the AC motor 32 may be changed by changing both the duty of first PWM signal and the duty of second PWM signals.

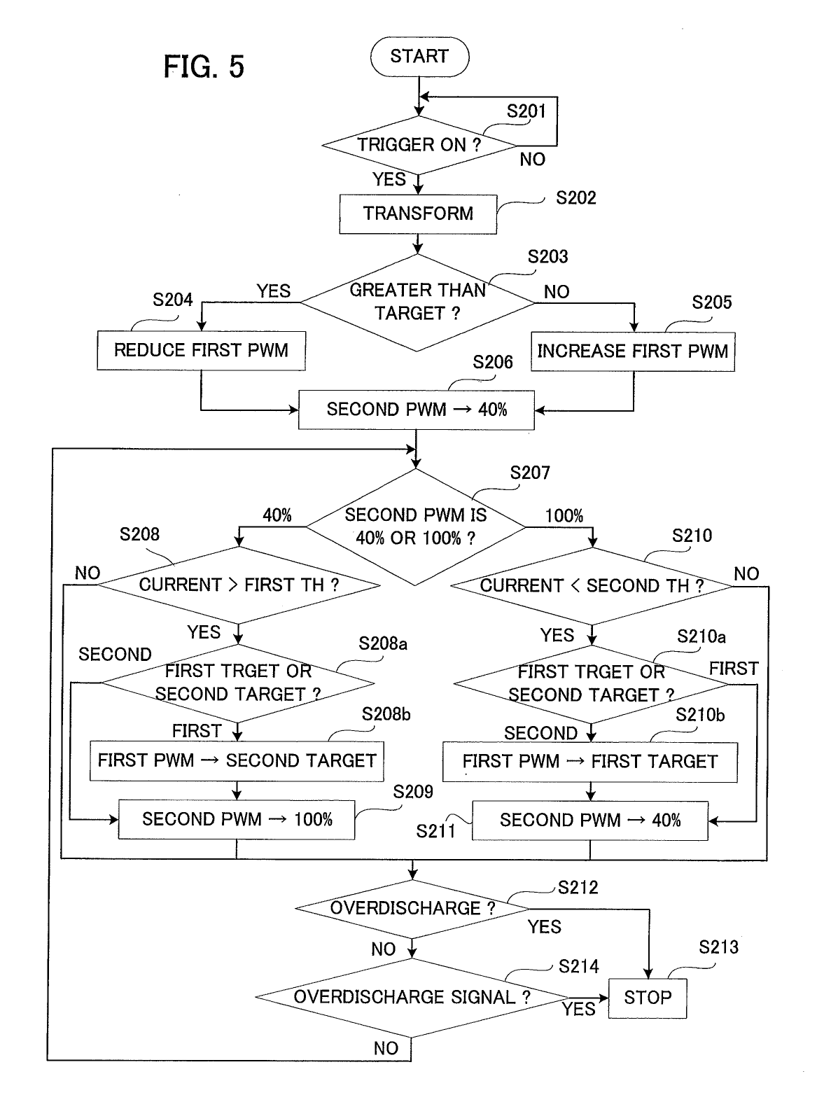

In this case, as shown in FIG. 5, the microcomputer 29 controls the FET 232 with the first PWM signal so that the transformed voltage approaches the first target voltage in S203-S205, and sets the duty of the second PWM signals to 40% in S206. Then, when the duty of the second PWM signals is set to 40% (S207: 40%) and the current (load) is greater than the first threshold (S208: YES), the microcomputer 29 determines which of the first target voltage and a second target voltage greater than the first target voltage the duty of the first PWM signal is set to a value for (S208a). When the duty of first PWM signal is set to a value for the first target voltage (S208a: first target voltage), the microcomputer 29 increases the duty of the first PWM signal to a value for the second target voltage (S208b) and also increases the duty of the second PWM signals to 100% (S209). Thus, the driving power supplied to the AC motor 32 is increased by increasing both the duty of first PWM signal and the duty of second PWM signals. On the other hands, when the duty of first PWM signal is set to a value for the second target voltage (S208a: second target voltage), the microcomputer 29 goes to S209.

On the other hands, when the duty of the second PWM signals is set to 100% (S207: 100%) and the current (load) is smaller than the second threshold (S210: YES), the microcomputer 29 determines which of the first target voltage and a second target voltage greater than the first target voltage the duty of the first PWM signal is set to a value for (S210a). When the duty of the first PWM signal is set to a value for the second target voltage (S210a: second target voltage), the microcomputer 29 decreases the duty of the first PWM signal to a value for the first target voltage (S210b) and also decreases the duty of the second PWM signals to 40% (S211). Thus, the driving power supplied to the AC motor 32 is decreased by decreasing both the duty of first PWM signal and the duty of second PWM signals. On the other hands, when the duty of first PWM signal is set to a value for the first target voltage (S210a: first target voltage), the microcomputer 29 goes to S211.

With this construction, it becomes possible to not only reduce a waste of an electrical power but also suppresses the heat generated in the FETs 232 and 261-264, when the mower 1 runs idle, or the load applied to the AC motor 32 is small although the mower 1 mows a lawn.

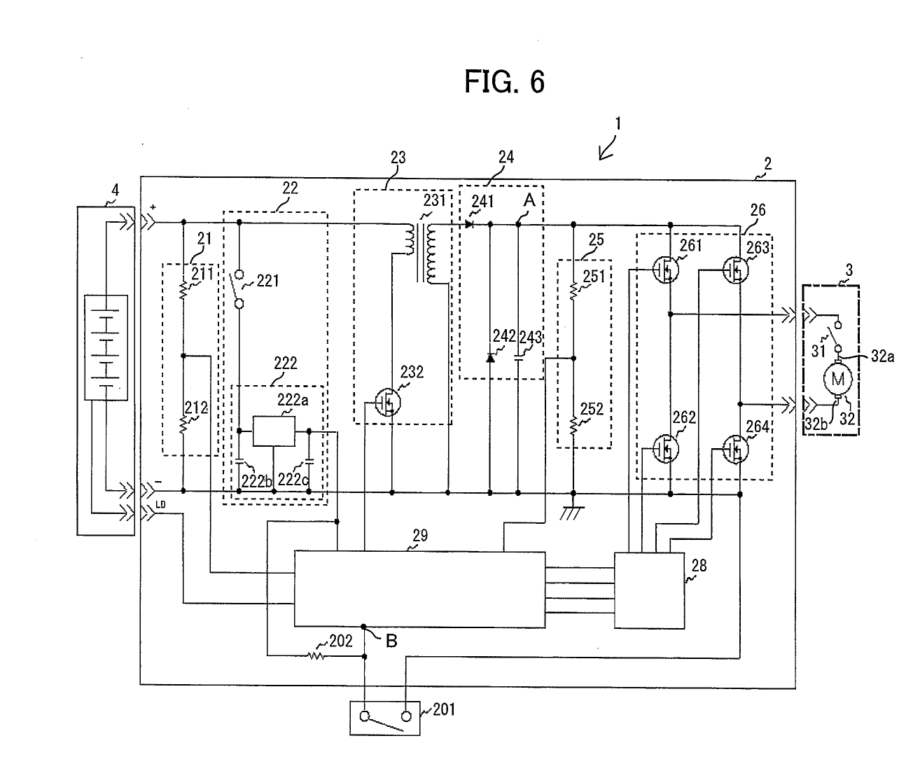

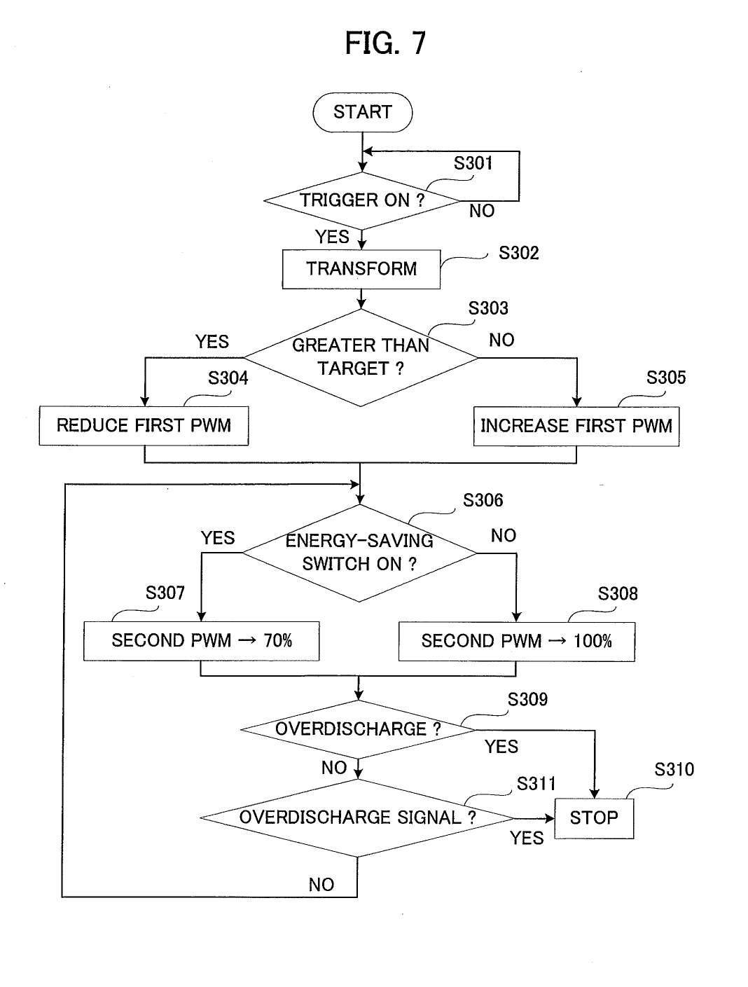

Next, a mower 1 according to a second embodiment of the present invention will be described with reference to FIGS. 6 and 7.

In the second embodiment, the driving power supplied to the AC motor 32 can be manually changed, although the driving power supplied to the AC motor 32 is automatically changed based on the load applied to the AC motor 32 in the first embodiment.

FIG. 6 is a circuit diagram of the mower 1 according to the second embodiment. In FIG. 6, like parts and components as FIG. 2 are designated by the same reference numerals, and the description is omitted.

The mower 1 according to the second embodiment is provided with an energy-saving switch 201 and a resistor 202, while being not provided with the current detecting resistor 27. The main body 3 is driven at an energy-saving mode when the energy-saving switch 201 is turned ON.

The energy-saving switch 201 and the resistor 202 are connected in series between the three-terminal regulator 222a and GND so that the resistor 202 is directly connected to the three-terminal regulator 222a. The connecting point between the resistor 202 and the energy-saving switch 201 is connected to the microcomputer 29. With this construction, when the energy-saving switch 201 is turned ON (energy-saving mode), 0V (Low) is inputted to an input port B of the microcomputer 29. On the other hands, when the energy-saving switch 201 is turned OFF, a predetermined DC voltage outputted from the three-terminal regulator 222a is inputted to the input port B of the microcomputer 29.

When the energy-saving switch 201 is turned OFF, the microcomputer 29 alternately turns ON the first set and the second set at 100% of duty by second PWM signals. On the other hands, the energy-saving switch 201 is turned ON, the microcomputer 29 alternately turns ON the first set and the second set at 70% of duty by second PWM signals. With this construction, a user can change the driving power supplied to the AC motor 32 in accordance with the user's wish. Therefore, for example, if the user turns ON the energy-saving switch 201 when mowing a little lawn, it becomes possible to reduce the waste of the electrical power.

Next, a voltage control performed by the microcomputer 29 will be described with reference to FIG. 7. The descriptions of S301-S305 and S309-S311 are omitted, since the operations in S301-S305 and S309-S311 are identical with the operations in S101-S105 and S112-S114 in FIG. 3, respectively.

In the second embodiment, in S306, the microcomputer 29 determines whether or not the energy-saving switch 201 has been turned ON (S306). When the energy-saving switch 201 has been turned ON (S306: YES), the microcomputer 29 sets the duty of the second PWM signals to 70% (S307). On the other hands, when the energy-saving switch 201 has not been turned ON (S306: NO), the microcomputer 29 sets the duty of the second PWM signals to 100% (S308).

As described above, since the mower 1 according to the second embodiment is provided with the energy-saving switch 201, a user can change the driving power supplied to the AC motor 32 in accordance with the user's wish. Therefore, for example, if the user turns ON the energy-saving switch 201 when mowing a little lawn, it becomes possible to reduce the waste of the electrical power.

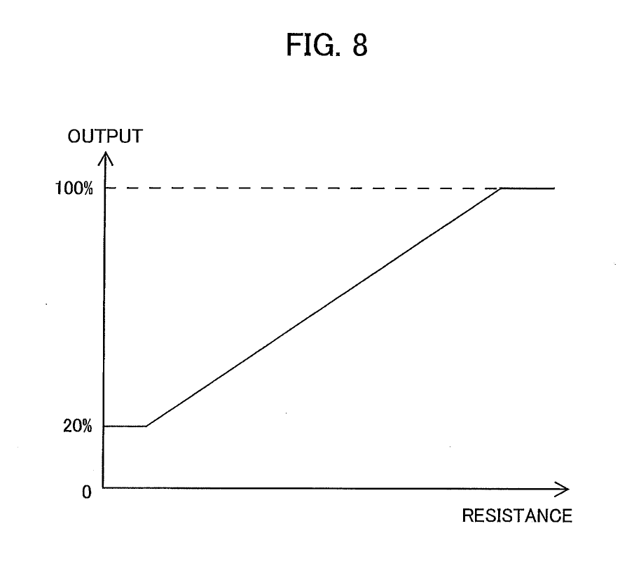

Note that a variable resistor having a dial may be disposed instead of the energy-saving switch 201. In this case, as show in FIG. 8, the driving power can be changed at non-step form by changing the resistance value of the variable resistor with the dial.

Further, in the second embodiment, the microcomputer 29 decreases the driving power supplied to the AC motor 32 by decreasing the duty of the FETs 261-264, when the energy-saving switch 201 is turned ON. However, the microcomputer 29 may decrease the driving power supplied to the AC motor 32 by decreasing the duty of the FET 232 when the energy-saving switch 201 is turned ON.

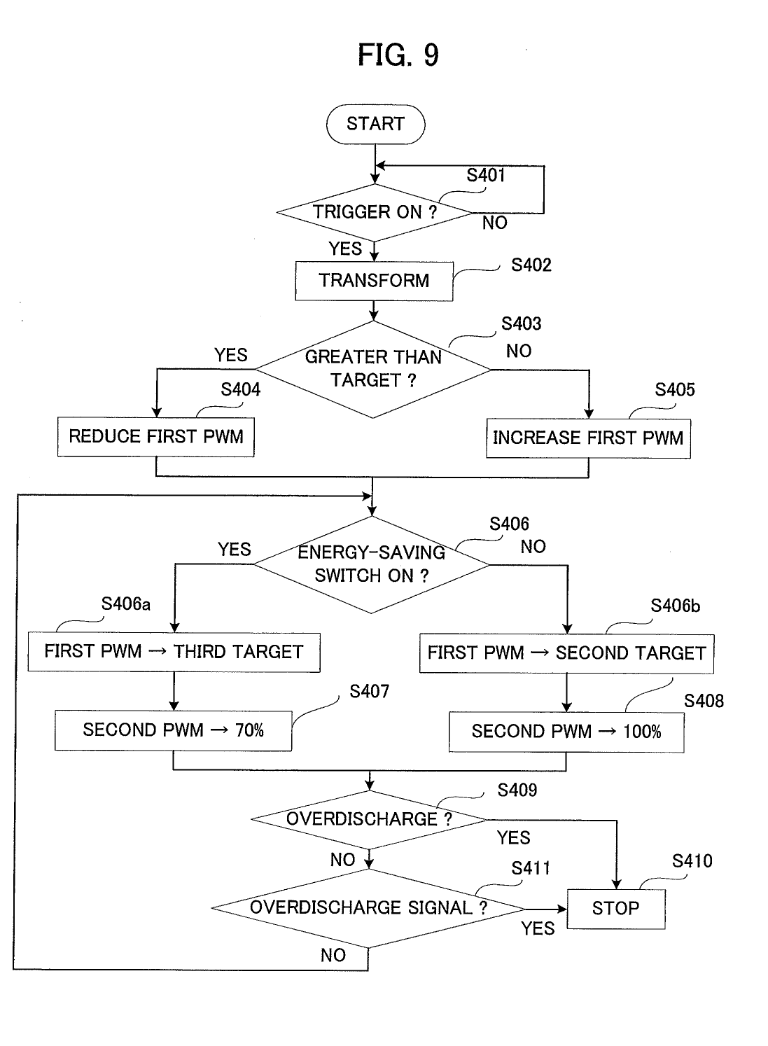

In this case, as shown in FIG. 9, the microcomputer 29 controls the FET 232 with the first PWM signal so that the transformed voltage approaches the first target voltage in S403-S405. Then, when the energy-saving switch 201 is turned ON (S406: YES), the microcomputer 29 decreases the duty of the first PWM signal so that a third target voltage smaller than the first target voltage is outputted from the transforming unit 23 (S406a), and sets the duty of the second PWM signals to 70% (S407). On the other hand, When the energy-saving switch 201 is turned OFF (S406: NO), the microcomputer 29 increases the duty of the first PWM signal so that the second target voltage greater than the first voltage is outputted from the transforming unit 23 (S406b), and sets the duty of the second PWM signals to 100% (S408).

With this construction, it becomes possible to not only reduce a waste of an electrical power but also suppresses the heat generated in the FETs 232 and 261-264.

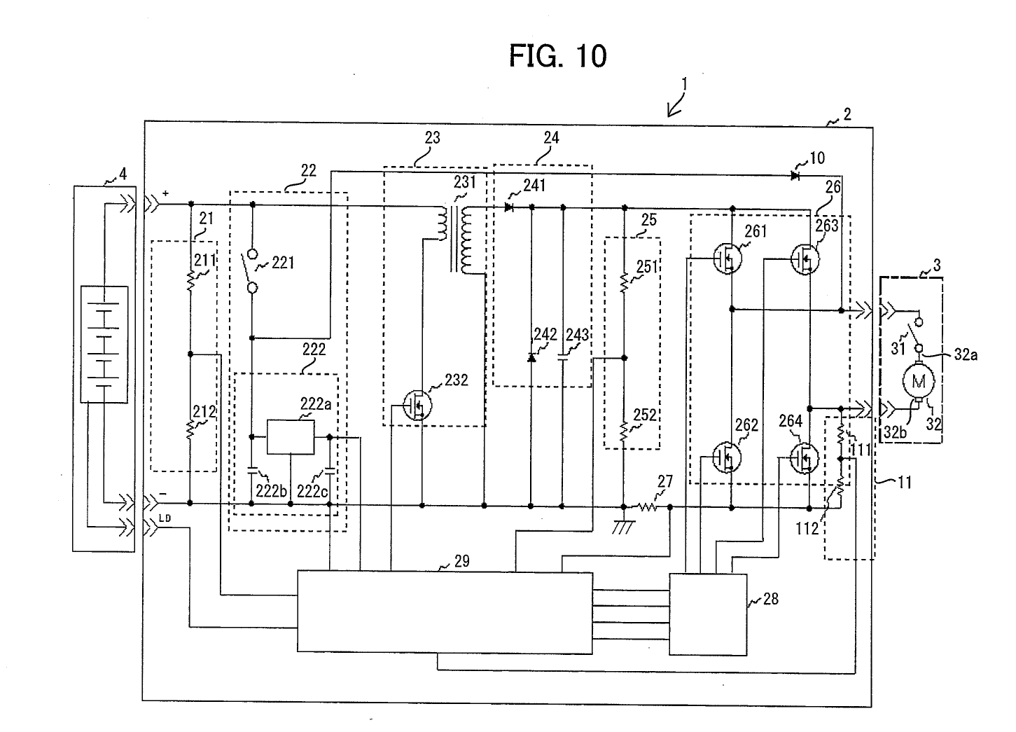

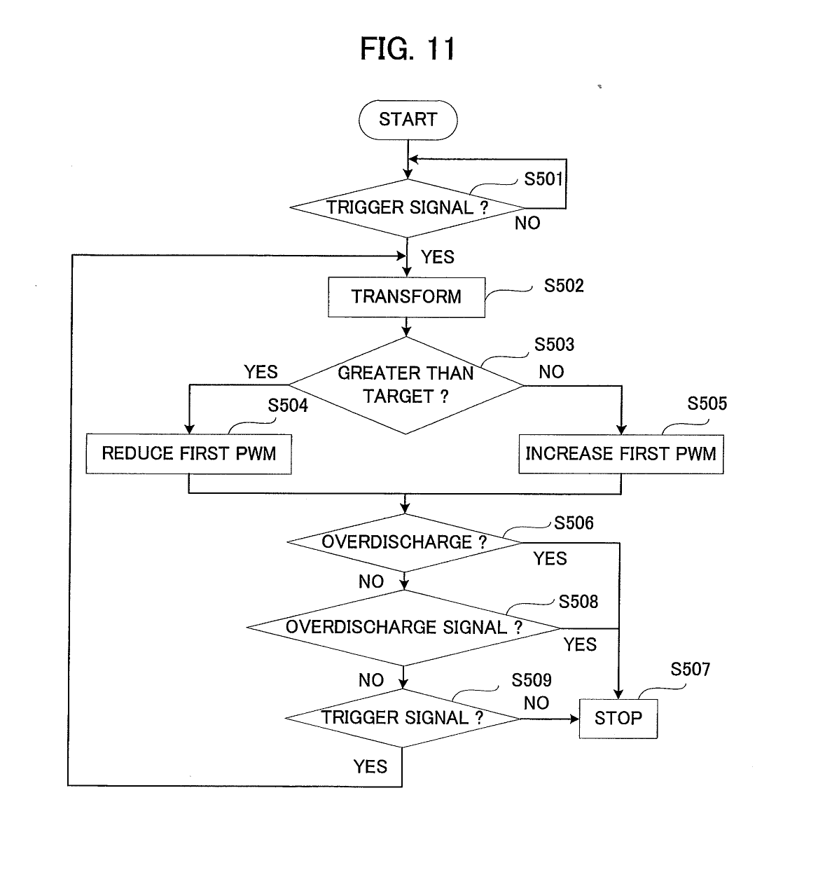

Next, a mower 1 according to a third embodiment of the present invention will be described with reference to FIGS. 10 and 11.

FIG. 10 is a circuit diagram of the mower 1 according to the third embodiment. In FIG. 10, like parts and components as FIG. 2 are designated by the same reference numerals, and the description is omitted.

In the first embodiment, when the power switch 221 is turned ON, the battery voltage of the battery pack 4 is supplied to the microcomputer 29 via the power source 22 even if the trigger switch 31 is turned OFF. As the result, an electrical power is wasted. In the third embodiment, the mower 1 is provided with a power switch detecting diode 10 and a trigger detecting unit 11 in order to reduce a waste of an electrical power when the trigger switch is turned OFF.

An anode of the power switch detecting diode 10 is connected to a low-voltage side of the power switch 221, and a cathode of the power switch detecting diode 10 is connected to the first terminal 32a of the AC motor 32 via the trigger switch 31. With this construction, when the power switch 221 is turned ON, the battery voltage of the battery pack 4 is applied to the AC motor 32.

The cathode of the power switch detecting diode 10 is also connected to the source of the FET 261. Therefore, when the FET 261 is turned ON, the DC voltage outputted from the rectifying/smoothing circuit 24 is applied to the AC motor 32.

The trigger detecting unit 11 includes resistors 111 and 112 connected in series between the second terminal 32b of the AC motor 23 and the GND, in other words, between the drain and the source of the FET 264. When both the power switch 221 and the trigger switch 31 are turned ON, the battery voltage of the battery pack 4 is applied to the trigger detecting unit 11 through the power switch 221, the power switch detecting diode 10, the trigger switch 31, and the AC motor 32. The battery voltage of the battery pack 4 is divided by the resistors 111 and 112, and outputted to the microcomputer 29 as a trigger detecting signal.

Note that the cathode of the power switch detecting diode 10 may be connected to the source of the FET 263, and the trigger detecting unit 11 may be connected between the drain and the source of the FET 262.

In the present embodiment, when the trigger switch 31 is turned OFF, that is, the trigger detecting signal is not inputted from the trigger detecting unit 11 into the microcomputer 29, the microcomputer 29 stops the ON/OFF operations of the FETs 232 and 261-264 by a first PWM signal and second PWM signals. With this construction, it becomes possible to reduce a waste of an electrical power when the trigger switch is turned OFF.

Next, a voltage control performed by the microcomputer 29 will be described with reference to FIG. 11.

A flowchart shown in FIG. 11 starts when the power switch 221 is turned ON in a state where the battery pack 4 has been connected to the inverter 2, or when the battery pack 4 is connected to the inverter 2 in a state where the power switch 221 has been turned ON. When the power switch 221 is turned ON and the battery pack 4 is connected to the inverter 2, a driving power is generated by the voltage regulator circuit 222, and the drive of the microcomputer 29 is started with the driving power.

First, the microcomputer 29 determines whether or not the trigger detecting signal is inputted from the trigger detecting unit 11, that is, the battery voltage of the battery pack 4 is applied to the trigger detecting unit 11 through the power switch 221, the power switch detecting diode 10, the trigger switch 31, and the AC motor 32 (S501). When the trigger detecting signal is inputted from the trigger detecting unit 11 (S501: YES), the microcomputer 29 determines that the trigger switch 31 is turned ON and starts the ON/OFF operation of the FET 232, that is, the transforming operation of the transformer 231 by a first PWM signal (S502).

Next, the microcomputer 29 determines, based on the transformed voltage detected by the transformed voltage detecting unit 25, whether or not the transformed voltage is greater than a target voltage (for example, 141V) (S503). When the transformed voltage is greater than the target voltage (S503: YES), the microcomputer 29 reduces the duty of the first PWM signal (S504). On the other hands, when the transformed voltage is smaller than the target voltage (S503: NO), the microcomputer 29 increases the duty of the first PWM signal (S505). Thus, the supply of the AC voltage to the AC motor 32 starts.

Next, the microcomputer 29 determines whether or not the battery voltage detected by the battery voltage detecting unit 21 is smaller than the first overdischarge voltage (S506). When the battery voltage detected by the battery voltage detecting unit 21 is smaller than the overdischarge voltage (S506: YES), the microcomputer 29 stops the ON/OFF operation of the FET 232 by a first PWM signal and the ON/OFF operations of the FETs 261-264 by second PWM signals to stop the operations of the transforming unit 23 and the inverter circuit 26 (S507). As the result, the power supply to the AC motor 32 is stopped.

When the battery voltage detected by the battery voltage detecting unit 21 is equal to or greater than the overdischarge voltage (S506: NO), the microcomputer 29 determines whether or not the overdischarge signal has been inputted from the battery pack 4 (S508). When the overdischarge signal has been inputted from the battery pack 4 (S508: YES), the microcomputer 29 stops the ON/OFF operation of the FET 232 by a first PWM signal and the ON/OFF operations of the FETs 261-264 by second PWM signals (S507).

On the other hands, when the overdischarge signal has not been inputted from the battery pack 4 (S508: NO), the microcomputer 29 determines whether or not the trigger detecting signal is inputted from the trigger detecting unit 11 again (S509). When the trigger signal is inputted from the trigger detecting unit 11 (S509: YES), the microcomputer 29 returns to S502. On the other hands, when the trigger signal is not inputted from the trigger detecting unit 11 (S509: NO), the microcomputer 29 stops the ON/OFF operation of the FET 232 by a first PWM signal and the ON/OFF operations of the FETs 261-264 by second PWM signals (S510), and returns to S501.

As described above, in the present embodiment, when the trigger switch 31 is turned OFF, the microcomputer 29 stops the ON/OFF operations of the FETs 232 and 261-264. Thus, it becomes possible to reduce a waste of an electrical power. Further, since the ON/OFF operations of the FETs 232 and 261-264 is stopped when the trigger switch 31 is turned OFF, the heat is prevented from being generated in the FETs 232 and 261-264, thereby the break of the FETs 232 and 261-264 being prevented.

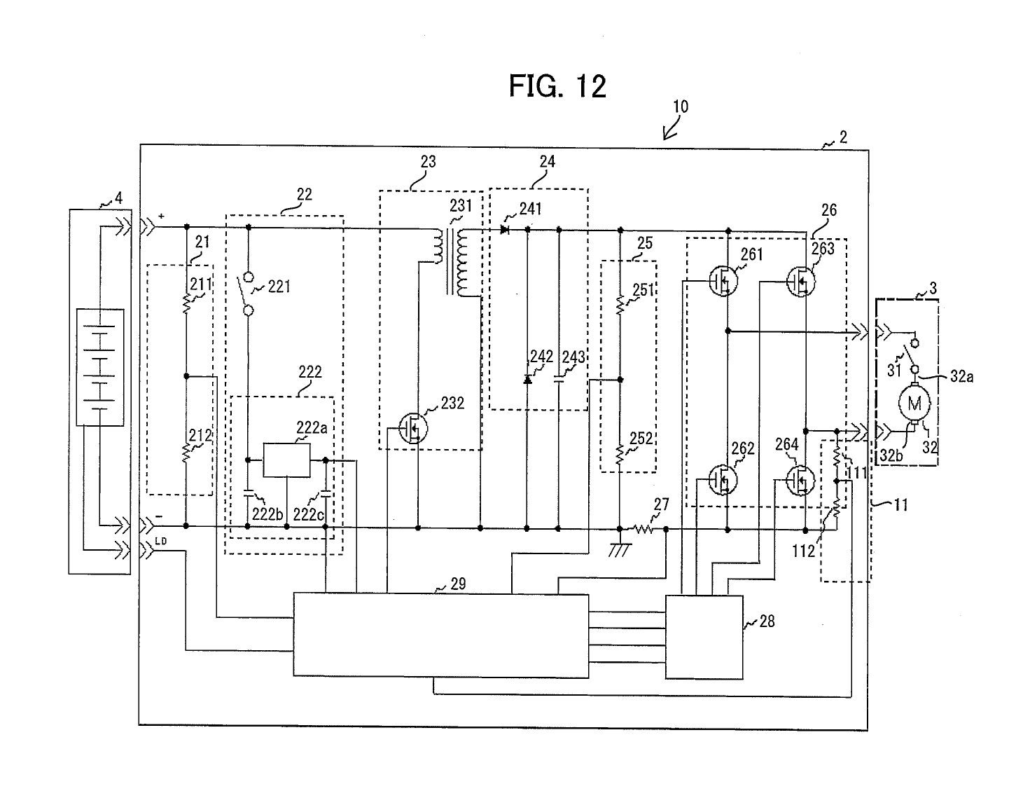

Next, a mower 1 according to a fourth embodiment of the present invention will be described with reference to FIG. 12.

FIG. 12 is a circuit diagram of the mower 1 according to the fourth embodiment. In FIG. 12, like parts and components as FIG. 10 are designated by the same reference numerals, and the description is omitted.

The mower 1 according to the fourth embodiment is not provided with the power switch detecting diode 10. In the present embodiment, when the power switch 221 is turned ON in a state where the trigger switch 31 is turned OFF, the microcomputer 29 starts the ON/OFF operation of the FET 232 by a first PWM signal. However, with respect to the FETs 261-264, the microcomputer 29 turns ON only the FET 261 by second PWM signals. With this construction, when the trigger switch 31 is turned ON, the DC voltage outputted from the rectifying/smoothing unit 24 is applied to the trigger detecting unit 11 through the FET 261, the trigger switch 31, and the AC motor 32, and divided by the resistors 111 and 112, and outputted to the microcomputer 29 as the trigger detecting signal. Further, in the present embodiment, when the trigger detecting signal is inputted from the trigger detecting unit 11 into the microcomputer 29, the microcomputer 29 starts the ON/OFF operations of all of the FETs 261-264.

As described above, in the present embodiment, when the trigger switch 31 is not turned ON, the microcomputer 29 stops the ON/OFF operations of the FETs 261-264. Thus, it becomes possible to reduce a waste of an electrical power. Further, since the ON/OFF operations of the FETs 261-264 is stopped when the trigger switch 31 is not turned ON, the heat is prevented from being generated in the FETs 261-264, thereby the break of the FETs 261-264 being prevented.

Note that the trigger detecting unit 11 may be disposed between the drain and the source of the FET 262. In this case, when the power switch 221 is turned ON in a state where the trigger switch 31 is turned OFF, the microcomputer 29 turns ON only the FET 263 instead of the FET 261.

Further, the microcomputer 29 reduces the duty of the first PWM signal when the trigger switch 31 is not turned ON than when the trigger switch 31 is turned ON. With this construction, it becomes possible to more effectively reduce a waste of an electrical power when the trigger switch 31 is not turned ON. However, by the first PWM signal whose duty is reduced, a voltage such the microcomputer 29 can determine that the trigger switch 31 has been turned ON must applied to the trigger detecting unit 11.

While the invention has been described in detail with reference to the embodiments thereof, it would be apparent to those skilled in the art that various changes and modifications may be made therein without departing from the spirit of the invention.

For example, the inverter 2 may be incorporated into the main body 3, although the inverter 2 is detachable from the main body 3 in the above embodiments. In this case, the circuits provided in the inverter 2 in the above embodiments are provided in the main body 3. Therefore, the manufacturing cost is greatly reduced by using the AC motor in a similar as the conventional AC mower.

Further, the microcomputer 29 may stop one of the FET 232 and FETs 261-264 in order to stop the power supply to the AC motor 32.

Further, a DC motor may be used instead of the AC motor 32. In this case, the voltage is adjusted before supplied to the DC motor.

Further, the mower 1 may be provided with another FET connected to the power switch 221 in series, and the battery pack 4 may be outputs the overdischarge signal to the gate of the FET when detecting the occurrence of the overdischarge. Thus, the life of the battery pack 4 is reliably prevented from being shorten, since the power supply to the microcomputer 29 is also stopped when the occurrence of the overdischarge is detected.

Further, at least one of the inverter 2 and the battery pack 4 may be provided with an alarm unit, such as, a display or a buzzer, that informing a user of the occurrence of the overdischarge, and stop the power supply to the microcomputer 29 after informing the user of the occurrence of the overdischarge. With this construction, the life of the battery pack 4 is prevented from being shorten without giving the user a feeling of strangeness.

Further, the second overdischarge threshold in the battery pack 4 may be set to a value smaller than the first overdischarge threshold in the inverter 2, although the first overdischarge threshold is set to a value smaller than the second overdischarge threshold in the above embodiments. In this case, S112 and S114 of FIG. 3, S212 and S214 of FIG. 5, S309 and S311 of FIG. 7, S409 and S411 of FIG. 9, and S506 and S508 of FIG. 11 are performed in a reverse order. Further, the occurrence of the overcurrent may be also detected by both the battery pack 4 and the inverter 2.

Further, the electrical power tool of the present invention is not limited to the mower. The present invention can be applied to an electrical power tool including a trigger switch and driven with an AC electrical power such as a hedge trimmer, a circular saw, a jigsaw, a grinder, and a driver.

Further, a plurality of battery pack 4 may be mounted on the main body 4, and be used sequentially. With this construction, it becomes possible to use the mower 1 for a long time.

Further, the control of the transformed voltage performed in S102-S105 of FIG. 3, S202-S205 of FIG. 5, S302-S305 of FIG. 7, S402-S405 of FIG. 9, and S502-S505 of FIG. 11 and the detection of the occurrence of the overdischarge performed in S112-S114 of FIG. 3, S212-S214 of FIG. 5, S309-S311 of FIG. 7, S409-S411 of FIG. 9, and S506-S508 of FIG. 11 can be performed in any step in the flowcharts and can be performed at a same time.

Further, the duty is not limited to a value described in the above embodiments.

What is claimed is:

1. An electrical power tool comprising:
a motor;
a load detecting unit that detects a load applied to the motor;
a trigger switch that receives an instruction; and
a power supplying unit that starts supplying of a driving electrical power to the motor when the trigger switch receives the instruction,
wherein the power supplying unit changes an amount of the driving electrical power based on the load detected by the load detecting unit.

2. The electrical power tool according to claim 1, wherein the power supplying unit determines a driving status of the motor based on the load detected by the load detecting unit, and changes the amount of the driving electrical power based on the determination.

3. The electrical power tool according to claim 2, wherein the power supplying unit reduces the amount of the driving electrical power when determining that the motor runs idle.

4. The electrical power tool according to claim 1, wherein the motor is driven with an AC electrical power,
wherein the power supplying unit includes:
a controller that generates an inverter PWM signal based on the load detected by the load detecting unit; and
an inverter circuit having an inverter switch element that is connected to the motor and performs an ON/OFF operation based on the inverter PWM signal to convert a DC electrical power supplied from a DC electrical power to an AC electrical power and supply the AC electrical power to the motor as the driving electrical power, the amount of the driving electrical power changing in accordance with the ON/OFF operation of the inverter switch element.

5. The electrical power tool according to claim 4, further comprising a transformer switch element electrically connected to the inverter circuit,
wherein the controller generates a transformer PWM signal,
wherein the DC electrical power is supplied from a battery pack to the transformer switch element, the transformer switch element performing an ON/OFF operation based on the transformer PWM signal, the DC electrical power being converted to the AC electrical power with the ON/OFF operation of the transformer switch element and outputted to the power supplying unit,
wherein the power supplying unit further includes:
a transformer that transforms the AC electrical power outputted from the transformer switch element; and
a rectifying/smoothing unit that rectifies and smoothes the transformed AC electrical power,
wherein the inverter circuit converts the rectified and smoothed AC electrical power to the AC electrical power, and
wherein the controller changes at least one of the inverter PWM signal and the transformer PWM signal based on the load detected by the load detecting unit.

6. The electrical power tool according to claim 5, wherein the controller generates an inverter PWM signal having a maximum duty and a transformer PWM signal having a maximum duty when the load detected by the load detecting unit is greater than a first threshold, and
wherein the controller generates an PWM signal having a duty smaller than the maximum duty when the load detected by the load detecting unit is smaller than a second threshold smaller than the first threshold, the PWM signal including at least one of the inverter PWM signal and the transformer PWM signal.

7. The electrical power tool according to claim 5, wherein the power supplying unit stops supplying of the driving electrical power supplied to the motor when an overdischarge signal is inputted from the battery pack.

8. The electrical power tool according to claim 1, wherein the load detecting unit detects the load based on a current flowing into the motor.

9. An electrical power tool comprising:
a motor;
a load detecting unit that detects a load applied to the motor;
a trigger switch that receives a first instruction;
a power supplying unit that starts supplying of a driving electrical power to the motor when the trigger switch receives the first instruction; and
a setting unit that receives a second instruction,
wherein the power supplying unit changes an amount of the driving electrical power when the setting unit receives the second instruction.

10. An electrical power tool comprising:
an AC motor driven with an AC electrical power;
a trigger switch that receives an instruction;
an inverter circuit that converts a DC electrical power supplied from a battery pack to an AC electrical power, and supplies the AC electrical power to the AC motor;
a controller configured to control the inverter circuit; and
a power switch, a driving electrical power being supplied to the controller when the power switch is turned ON,
wherein the controller controls the inverter circuit to start converting the DC electrical power to the AC electrical power after the trigger switch receives the instruction.

11. The electrical power tool according to claim 10, further comprising:
a transformer switch element connected between the battery pack and the inverter circuit, the DC electrical power being supplied from the battery pack to the transformer switch element and converted to an AC electrical power by an ON/OFF operation of the transformer switch element;
a transformer that transforms the AC electrical power outputted from the transformer switch element;
a rectifying/smoothing unit that rectifies and smoothes the transformed AC electrical power, the inverter circuit converting the rectified and smoothed AC electrical power to the AC electrical power; and
a transmitting unit that transmits the DC electrical power supplied from the battery pack to the controller via the AC motor when the trigger switch receives the instruction,
wherein the controller controls the inverter circuit to start converting the DC electrical power to the AC electrical power after the DC electrical power is transmitted via the AC motor.

12. The electrical power tool according to claim 11, wherein the power switch is disposed between the battery pack and the controller, and the transmitting unit is disposed between a connecting point between the power switch and the controller and the AC electrical motor.

13. The electrical power tool according to claim 11, further comprising a trigger detecting unit having a plurality of resistors connected to the AC motor in series, the DC electrical power supplied from the battery pack being divided by the plurality of resistors and outputted to the controller,
wherein the controller controls the inverter circuit to start converting the DC electrical power to the AC electrical power after the divided DC electrical power is inputted.

14. The electrical power tool according to claim 10, further comprising:
a transformer switch element connected between the battery pack and the inverter circuit, the DC electrical power being supplied from the battery pack to the transformer switch element and converted to an AC electrical power by an ON/OFF operation of the transformer switch element;
a transformer that transforms the AC electrical power outputted from the transformer switch element; and
a rectifying/smoothing unit that rectifies and smoothes the transformed AC electrical power, the inverter circuit converting the rectified and smoothed AC electrical power to the AC electrical power,
wherein the inverter circuit includes a plurality of inverter switch elements connected between the rectifying/smoothing unit and the AC motor, the rectified and smoothed AC electrical power being converted to an AC electrical power by ON/OFF operations of the plurality of inverter switch elements,
wherein the controller controls the inverter circuit to start converting the DC electrical power to the AC electrical power after the DC electrical power is inputted via the AC motor, and
wherein the controller controls one inverter switch element to turn ON and the other inverter switch element to turn OFF until the DC electrical power is inputted via the AC motor.

15. The electrical power tool according to claim 14, further comprising a trigger detecting unit having a plurality of resistors connected to the AC motor in series, the DC electrical power supplied from the battery pack being divided by the plurality of resistors and outputted to the controller,
wherein the controller controls the inverter circuit to start converting the DC electrical power to the AC electrical power after the divided DC electrical power is inputted,
wherein the plurality of inverter switch includes a first switch, a second switch connected to the first switch, a third switch, and a fourth switch connected to the third switch, the first switch and the third switch being connected to a positive terminal of the battery pack, the second switch and the fourth switch being connected to a negative terminal of the battery pack, the AC motor being connected between a connecting point between the first switch and the second switch and a connecting point between the third switch and the fourth switch, the trigger detecting unit being connected to the fourth switch in parallel, and
wherein the controller controls the first switch to turn ON and the second switch, the third switch, and the fourth switch to turn OFF until the DC electrical power is inputted via the AC motor.

16. The electrical power tool according to claim 10, further comprising:
a transformer switch element connected between the battery pack and the inverter circuit, the DC electrical power being supplied from the battery pack to the transformer switch element and converted to an AC electrical power by an ON/OFF operation of the transformer switch element;
a transformer that transforms the AC electrical power outputted from the transformer switch element; and
a rectifying/smoothing unit that rectifies and smoothes the transformed AC electrical power, the inverter circuit converting the rectified and smoothed AC electrical power to the AC electrical power,
wherein the controller controls the transformer switch element to start the ON/OFF operation after the trigger switch receives the instruction.

17. The electrical power tool according to claim 10, wherein the controller controls the inverter circuit to stop converting the DC electrical power to the AC electrical power when an overdischarge signal is inputted from the battery pack.

18. An inverter device comprising;
a main body;
a load detecting unit that detects a load applied to a motor which is connected to the main body; and
a power supplying unit that starts supplying of a driving electrical power to the motor,
wherein the power supplying unit changes an amount of the driving electrical power based on the load detected by the load detecting unit.

19. An inverter device comprising:
a main body;
an inverter circuit that converts a DC electrical power supplied from a battery pack to an AC electrical power, and supplies the AC electrical power to a AC motor which is connected to the main body;
a controller configured to control the inverter circuit; and
a power switch, a driving electrical power being supplied to the controller when the power switch is turned ON,
wherein the controller controls the inverter circuit to start converting the DC electrical power to the AC electrical power after a trigger switch connected to the AC motor in series is operated.
